(19) United States
(12) Patent Application Publication
(10) Pub. No.: US 2017/0342227 A1
(43) Pub. Date: Nov. 30, 2017

(54) COMPOSITE MATERIAL AND RELATED ARTICLES AND METHODS

(71) Applicant: Victrex Manufacturing Limited, Lancashire (GB)

(72) Inventor: Michael John PERCY, Lancashire (GB)

(73) Assignee: Victrex Manufacturing Limited, Lancashire (GB)

(21) Appl. No.: 15/536,066

(22) PCT Filed: Dec. 15, 2015
(86) PCT No.: PCT/GB2015/054017

§ 371 Date: Jun. 14, 2017

(30) Foreign Application Priority Data
Dec. 15, 2014 (GB) 1422241.8

(51) Int. Cl. C08J 7/04; B29C 70/38; B29C 70/50; B32B 5/12; B32B 27/42; B32B 37/06; C08J 5/12; B32B 27/08; B29C 70/16; B29K 105/00; B29L 9/00; B29K 71/00

(52) U.S. Cl. CPC C08J 7/047; B32B 27/08; B29C 70/386; B29C 70/504; B32B 5/12; B29C 70/16; B32B 27/42; B32B 37/06; C08J 5/12; B29L 2009/005; B29K 2071/00; B32B 2305/10; B32B 2371/00; B29K 2105/256; C08J 2361/16; C08J 2461/16

(57) ABSTRACT

A reinforcement sheet has a composite layer including fibres and a polymer A and a coating layer including polymer B, each polymer having at least 65 mol % of a repeat unit of formula:

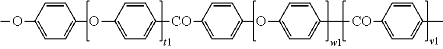

wherein for each polymer A and B, t1, and w1 independently represent 0 or 1 and v1 represents 0, 1 or 2. A method of forming the reinforcement sheet is also disclosed, in addition to a method for forming an article comprising a laminate of the reinforcement sheets and the article comprising such a laminate. The repeat unit may be ether-ether-ketone.

### FIELD

The invention relates to reinforcement sheets formed from fibres embedded in thermoplastic polymeric materials. In certain embodiments, the invention is concerned with reinforcement sheets in the form of reinforcement tapes suitable for use in manufacture of fibre-reinforced articles using rapid manufacturing processes such as ATL (Automated Tape Laying), ATP (Automated Tape Placement), hot stamping and the like.

### BACKGROUND TO THE INVENTION

Over the last two decades, the so called advanced reinforced thermoplastic materials, based on composite materials having fibres embedded in a thermoplastic polymer, have been increasingly used in several industries, such as aerospace, automotive, general manufacturing, chemical, oil and gas, medical, sport and leisure. One of the main drivers for the use of composites is weight reduction. Their high strength and stiffness at low weight allows composites to partly or fully replace metals for many applications. Such composite materials can provide good performance and controlled properties through high fibre volume fractions and well-defined fibre alignment within the composite.

The processing technology for advanced reinforced thermoplastic materials has mirrored that of advanced thermosetting composites. Such composites, based on thermosetting materials, have been in widespread industrial use for over 40 years. Although many of the processing methods are similar, thermoplastic composites can typically be processed into a completed article that equivalent thermosetting composites. For thermoplastic composites, cycle times of the order of from a few seconds to a few minutes for forming articles are common, whereas thermosetting composites may require several minutes, up to several hours, for manufacture of industrial components.

Advanced reinforced thermoplastic materials may be used in the form of sheets or tapes, in which reinforcing fibres are embedded in a thermoplastic matrix polymer. The manufacture of tapes is described in, for instance, U.S. Pat. No. 4,626,306 where an aqueous dispersion impregnation method is set out. Other descriptions for the formation of such tapes may be found in “Impregnation Techniques for Thermoplastic Matrix Composites”—A Miller and A G Gibson, Polymer & Polymer Composites 4 (7) 459-481 (1996), in patent application publication EP 0592473 A1 and specifically for melt impregnation in the patent application publications EP 0102158 A2 or EP 0102159 A2.

Such sheets or tapes may be used to manufacture composite articles by using processes in which the sheets or tapes are formed and consolidated together, typically subjected to heat to make the thermoplastic polymer malleable, and pressure to shape the component, followed by a cooling step to return the thermoplastic polymer to a solidified state.

Cost reduction is another important technology driver and it has led to the automation of manufacturing processes for thermoplastic composites, with the aim being shorter manufacturing cycle times and higher production speeds.

ATL (Automated Tape Laying), ATP (Automated Tape Placement) for advanced reinforced thermoplastic materials have been developed in recent years. Each process is a kind of a thermal welding process.

In these processes, a composite tape, typically comprising fibres and a thermoplastic polymer, is fed into a nip of roller, where heat is applied to the tape prior to its deposition onto a substrate. The roller may also heat the substrate onto which the tape is to be deposited (typically this may be a layer of tape deposited in a previous step).

Under pressure from the roller and/or tension in the sheet or tape, the sheet or tape becomes bonded to the substrate as the thermoplastic polymer within the composite, and within the substrate, melts and adheres the tape to the substrate. Then cooling and solidification of the thermoplastic polymer leads to consolidation of the tape as part of the substrate to which it was applied. This is as shown in FIG. 1, explained in more detail below.

Typical manufacturing velocities for the rate of laydown of tape are from 0.1 m/min up to 60 m/min, preferably from 1 m/min up to 60 m/min. As production velocities, increase, there is a risk that the degree of bonding of the tape to the substrate may decrease and this can lead to the tape or reinforcement sheet delaminating from the substrate. This may also influence the ILS (Interlaminar Shear Strength) when referring to sheets (laminae) of composite materials bonded as a laminate structure, and this in turn affects the mechanical characteristics of any resulting laminated article formed from the sheets or tape.

Semi-crystalline thermoplastic polymers are extremely useful as the embedding thermoplastic polymer matrix. This is because semi-crystalline polymers usually have greater mechanical and chemical resistance compared to amorphous polymers. However, at high processing speeds, the degree of recrystallization following melting may be too low to provide adequate crystallization in the thermoplastic polymer.

US patent application publication 2013/033788-A discloses a composite tape having a fibre-rich portion and a resin-rich portion formed at least one surface of the tape by over-impregnation of the fibre matrix with a single polymer resin to leave a surface layer of resin. The resulting tape demonstrates a rough and uneven interface between the fibre-rich portion and resin-rich portion.

US patent application publication 2011/0097575 discloses a composite tape having a core composite layer including a fibrous substrate and a high performance polymer, and a surface layer polymer applied to at least one surface of the core composite layer. The surface layer is chosen from an amorphous polymer, a slow-crystallising semi-crystalline polymer or mixtures thereof.

### SUMMARY OF THE INVENTION

It is an object of the invention, amongst others, to address the aforementioned problems. In particular it is one object of the invention, amongst others, to provide a composite reinforcement sheet suitable for use in high velocity automated tape laying or placement, which has good bonding in use, and/or low risk of delamination in use and which may provide good interlaminar shear strength when bonded as part of a laminate structure. It is also an object of the invention to provide methods for forming such reinforcement sheets and articles comprising such sheets.

Another object of the invention is to provide alternatives to prior art reinforcement sheets, articles comprising such sheets and related prior art methods.

According to a first aspect of the invention, there is provided a reinforcement sheet comprising:
a composite layer having first and second faces, the composite layer comprising fibres and a first polymer A, the first polymer having at least 65 mol % of a first repeat unit A′ of formula

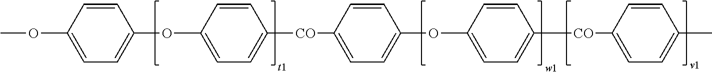

wherein t1, and w1 independently represent 0 or 1 and v1 represents 0, 1 or 2; and
a coating layer applied to the first face, and defining an interface therebetween, the coating layer comprising a second polymer B, wherein the second polymer comprises at least 65 mol % of a second repeat unit B′ of formula

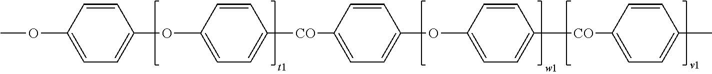

wherein t1, and w1 independently represent 0 or 1 and v1 represents 0, 1 or 2.

A second aspect of the invention provides a method of forming a reinforcement sheet according to the first aspect of the invention, the method comprising

i) providing the composite layer comprising fibres and the first polymer A; and

ii) depositing the coating layer comprising the second polymer B onto the respective face of the composite layer.

A third aspect of the invention provides a method for forming an article comprising a laminate of reinforcement sheets according to any one of claims 1 to 16 bonded to a substrate, the method comprising:
a) melt-bonding the coating layer of a reinforcement sheet according to the first aspect of the invention to the substrate to form a topmost bonded reinforcement sheet;
b) melt-bonding the coating layer of a further reinforcement sheet according to the first aspect of the invention to the bonded topmost reinforcement sheet whereby the further reinforcement sheet becomes the topmost bonded reinforcement sheet;
c) repeating step (b) as required to provide the laminate of reinforcement sheets.

A fourth aspect of the invention provides an article comprising a laminate of reinforcement sheets according to the first aspect of the invention.

### DETAILED DESCRIPTION OF THE INVENTION

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components. When referring to polymers, reference to a polymer “consisting essentially” of a particular repeat unit typically means that the polymer comprises at least 99 molar % of that monomer.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and may also be taken to include the meaning “consists of” or “consisting of”.

The term mol % or molar percentage as used herein in the context of a repeat unit of a polymer refers to the molar proportion of that repeat unit relative to all repeat units present in the polymer, expressed as a percentage and based upon the amounts of monomers used in the polymer preparation.

The optional and/or preferred features set out herein may be used either individually or in combination with each other where appropriate and particularly in the combinations as set out in the accompanying claims. The optional and/or preferred features for each aspect or exemplary embodiment of the invention, as set out herein are also applicable to any other aspects or exemplary embodiments of the invention, where appropriate. In other words, the skilled person reading this specification should consider the optional and/or preferred features for each aspect or exemplary embodiment of the invention as interchangeable and combinable between different aspects or exemplary embodiments.

The first aspect of the invention provides a reinforcement sheet comprising:
a composite layer having first and second faces, the composite layer comprising fibres and a first polymer A, the first polymer having at least 65 mol % of a first repeat unit A′ of formula

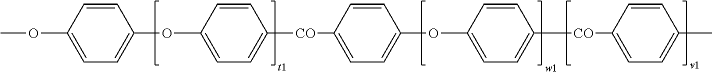

wherein t1, and w1 independently represent 0 or 1 and v1 represents 0, 1 or 2; and
a coating layer applied to the first face, and defining an interface therebetween, the coating layer comprising a second polymer B, wherein the second polymer comprises at least 65 mol % of a second repeat unit B′ of formula

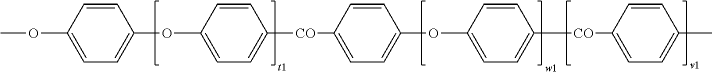

wherein t1, and w1 independently represent 0 or 1 and v1 represents 0, 1 or 2.

The first polymer A may comprise at least 65 mol % such as 75 mol %, for instance at least 80 mol % or at least 90 mol % of first repeat unit A′, and preferably consists essentially of repeat unit A′.

The second polymer B may comprise at least 65 mol %, such as at least 75%, for instance at least 80 mol % of second repeat unit B′, preferably comprising at least 90 mol % of second repeat unity B′, and even more preferably consisting essentially of repeat unit B′.

In other words, the polymers A and B are suitably polyaryletherketones (PAEKs) which each specifically and individually include at least 65 mol % of repeat units A′ and B′ respectively, with A′ and B′ being individually and separately according to the formula

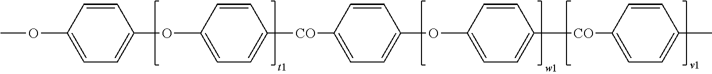

wherein t1, and w1 independently represent 0 or 1 and v1 represents 0, 1 or 2.

In a preferred embodiment for all aspects of the invention, the first repeat unit A′ and the second repeat unit B′ may be the same repeat unit, having common values for t1, w1 and v1.

In particular, for a more preferred embodiment for all aspects of the invention, the first repeat unit A′ and the second repeat unit B′ may both be according to the formula:

—O-Ph-O-Ph-CO-Ph-

wherein Ph represents a phenylene moiety. This repeat unit is sometimes referred to as ether-ether-ketone or EEK, with the polymers comprising such repeat units referred to as polyetheretherketones or PEEK. In other words, t1=1, w1=0 and v1=0.

In one suitable exemplary embodiment of the first aspect of the invention, and also in the other aspects of the invention, the second polymer B may comprise up to, and including, 35 mol % (i.e. from 0 mol % to 35 mol %) of a third repeat unit C′ according to the formula:

—O-Ph-Ph-O-Ph-CO-Ph-

wherein Ph represents a phenylene moiety. This repeat unit may be referred to in the art by the acronym EDEK (ether diphenyl ether ketone), with the corresponding polymer referred to using the acronym PEDEK. Hence, in preferred embodiments of the various aspects of the invention, the second polymer B may be a PEEK/PEDEK copolymer, consisting essentially of EEK and EDEK repeat units, with 65 mol % or more of EEK and 35 mol % or less of EDEK units.

However, to avoid any doubt, it is also within the scope of the invention that the second polymer B may contain none of this specific EDEK repeat unit C′.

The Tm of the first polymer A may be 300° C. or more, such as 320° or more, for instance 330° C. or more such as about 340° C. (i.e. from 335 to 345° C.). Tm is the melting temperature as measured by DSC and measurement details are set out below, and will typically be 400° C. or less such as 380° C. or less.

The Tm of the second polymer B may be the same as, or different to, the Tm of the first polymer. In a preferred embodiment of the first aspect of the invention, also applicable to the other aspects of the invention, Tm for the second polymer B may be lower than Tm for the first polymer A, providing the advantage that the second polymer B may be melt-bonded in use of the reinforcement sheet whilst the first polymer A remains in a substantially solid or just molten state, such as with polymer A at a few degrees above the Tm of polymer A, such as 5 to 20° C. above the Tm of polymer A. So, for instance, the Tm of the second polymer B may from 60° C. to 5° C. lower than Tm for polymer A, such as from 50 to 10° C. for instance from 40 to 15° C. lower. When the second polymer B is a polymer consisting essentially of PEEK/PEDEK, the Tm may be, for instance, from 300 to 320° C. for polymer B, depending upon the molar ratio of PEEK to PEDEK.

The polymer A suitably has a melt viscosity, MV, of 0.06 kNsm⁻² or more wherein MV is measured using capillary rheometry operating at 400° C. at a shear rate of 1000 s⁻¹ using a circular cross-section tungsten carbide die of 0.5 mm capillary diameter×3.175 mm capillary length. The MV measurement is taken 5 minutes after the polymer has fully melted, which is taken to be typically 5 minutes after the polymer is loaded into the barrel of the rheometer: i.e. 10 minutes in total after loading of the polymer. Such MV measurements are known in the prior art as suitable methods for estimating the molecular weight of PAEKs such as PEEK. This is particularly the case where the polymer A is a PEEK or consists essentially of EEK repeat units as set out hereinbefore. Preferably the polymer A has an MV of up to 0.70 kNsm⁻², more preferably up to 0.60 kNsm⁻², even more preferably up to 0.50 kNsm⁻², wherein MV is measured as described above.

The polymer B suitably has a melt viscosity, MV, of 0.06 or more measured at 400° C. and 1000 s⁻¹. For instance, the MV for polymer B may be 0.10 or more such as 0.15 or more. Preferably the polymer B has an MV of up to 0.70 kNsm⁻², more preferably up to 0.60 kNsm⁻², even more preferably up to 0.50 kNsm⁻², wherein MV is measured as described above.

The polymer A and the polymer B may each be a blend of polymers of different molecular weights. The skilled person understands that a polymerisation reaction will typically generate a distribution of polymer molecular weights for the resulting product. The polymer A and/or the polymer B may each be a single reaction product, or may be a blend of reaction products from different reactions providing polymers of differing molecular weights.

Preferably, the polymers A and B are polymers formed by nucleophilic reaction. The polymers A and B may each individually be homopolymers or copolymers, such as block copolymers or random copolymers.

The level of crystallinity in the polymeric material A is suitably 20% or more, preferably 25% or more, more preferably 30% or more. The level of crystallinity in the polymeric material B is suitably 20% or more, preferably at 25% or more, more preferably 30% or more.

A skilled person can readily assess whether a polymer is semi-crystalline, and the level of crystallinity, for example, by wide angle X-ray diffraction (also referred to as Wide Angle X-ray Scattering or WAXS) or by Differential Scanning calorimetry (DSC).

More particularly, the level and extent of crystallinity in a polymer may be measured by wide angle X-ray diffraction as described by Blundell and Osborn (Polymer 24, 953, 1983). The level of crystallinity may also be measured by DSC in a process which is described in POLYMER Vol. 37, Number 20, 1996, page 4573. Crystallinity may be assessed by a variety methods for polymers, for example by density, by IR (infrared) spectroscopy, by X-ray diffraction or by differential scanning calorimetry (DSC).

Unless otherwise specified, levels of crystallinity for polymers, as referred to herein, are as measured by DSC using the methodology detailed as follows:

Differential Scanning Calorimetry to Assess Crystallinity

The DSC method was been used to evaluate the crystallinity of polymers described herein using a Mettler Toledo DSC1 Star system with FRS5 sensor.

The Glass Transition Temperature (Tg), the Melting Temperature (Tm) and Heat of Fusions of Melting (ΔHm) for the polymers described herein may be determined using the following DSC method.

An 8 mg sample of the polymer is heated from 30° C. to 400° C. at 20° C./min, held for 5 minutes, then cooled at 20° C./minute to 30° C. and held for 5 minutes at this temperature. From the resulting curve obtained, the glass transition temperature Tg, is obtained as the intersection of the lines drawn along the pre-transition baseline and a line drawn along the greatest slope obtained during the transition. The melting temperature, Tm, is the temperature at which the main peak of the melting endotherm reaches a maximum.

The heat of fusion for melting (ΔHm) is obtained by connecting the two points at which the melting endotherm deviates from the relatively straight baseline. The integrated area under the endotherm as a function of time yields the enthalpy (mJ) of the melting transition. The mass normalised heat of fusion is calculated by dividing the enthalpy by the mass of the specimen to give a heat of fusion value in J/g. The level of crystallisation (%) is determined by dividing the heat of fusion of the specimen by the heat of fusion of the totally crystalline polymer to be measured; this is calculated as described by Blundell and Osborn (Polymer 24, 953, 1983). For polyetheretherketone, PEEK, and for PEEK-based polymers such as PEEK/PEDEK polymers as described herein, the heat of fusion of a totally crystalline polymer may be taken to be 130 J/g.

The aforementioned method, using DSC, provides the level of crystallinity in a bulk sample. Such bulk samples may be easily obtained from the composite layer or from the coating layer prior to application of the coating layer to one or more surfaces of the composite layer. When it is desired to measure the crystallinity of the coating layer after application to a surface of the composite layer to form a reinforcement sheet according to the first aspect of the invention, or, for instance within an article according to the fourth aspect of the invention, this may be achieved by cutting a sample from the reinforcement sheet or article and cutting away a sample of polymer from the relevant portion of the reinforcement sheet or article. To obtain a sample of coating layer from the reinforcement sheet, after application, for measurement by DSC, the sheet may be cut in the transverse direction and the end of the coating layer teased away from the reinforcement sheet by flexing the sheet and by using a sharp knife. The coating layer may then be peeled away easily and cleanly from the underlying composite layer.

As an alternative, e.g. when the coating layer has been melt bonded to the underlying composite layer and is consequently difficult to remove, FTIR (Fourier Transform Infrared) spectrometry may be used to assess the crystallinity of a surface and/or across the thickness or surface of a cross-sectional sample. Reference is made to a paper titled “Crystallinity in Poly(Aryl-Ether-Ketone) Plaques Studied by Multiple Internal Reflection Spectroscopy” (Polymer Bull, 11, 433 (1984)). It will be understood that the FTIR measurement may be calibrated using bulk samples of polymer of known crystallinity.

The composite layer in the first, or any other aspect of the invention, may comprise from 30% to 75% by weight of fibres and from 70 to 25% by weight of the first polymer A, preferably with the composite layer consisting essentially of the fibres and the first polymer A.

The coating layer may comprise at least 90% by weight of the second polymer B. Preferably the coating layer may consist essentially of the second polymer B.

Preferably, the fibres of the composite layer do not extend into the coating layer. By this it is meant that in applying the coating layer according to the invention, it is preferable that the composite layer is not disrupted so that the surface roughness of the surface of the composite layer before application of the coating layer is substantially unchanged when it instead forms an interface with the coating layer after application of the coating layer. This may be achieved, for instance, by applying the coating layer in a manner such that the polymer A of the composite layer is not in a fully molten state during application of the coating layer.

Preferably, the coating layer has a substantially uniform thickness and a low surface roughness both before and after application of the coating layer to the composite layer when forming the reinforcement sheet of the first aspect of the invention. Preferably, the coating layer has a thickness which varies by +/−2.0 μm or less from a mean thickness of the coating layer, more preferably 1.7 μm or less.

Preferably, the coating layer has a mean surface roughness Ra of 1.2 micrometres or less. This surface roughness is suitably measured using a surface profilometer such as a Taylor Hobson ‘Form Talysurf Intra’ instrument in accordance with the standards of measurement as set out in ISO 4288:1966 ‘Geometric Product specifications—Surface texture: Profile method—Terms, definitions and surface texture parameters’.

The instrument is suitably operated with a 112/2009 2 μm conical diamond stylus and calibrated using a 12.4941 mm radius ball standard with a gauge range set to 1.040 mm and measurement speed of 1.0 mm/s with a data length of 1.5 mm and run-up length 0.30 mm.

The stylus is lowered on to the sample and the measurement carried out with a measurement speed of 1 mm/s and a run up length of 0.3 mm and with the following parameters:

Data length=4 mm with 5 cut-offs

Cut-off (Lc)=0.8 mm

Cut off (Ls)=0.0025 mm

Bandwidth 300:1

Preferably, the first and second faces of the composite layer each have a mean surface roughness Ra of 2.0 micrometres or less measured prior to any application of the coating layer. It will be understood that such roughness may arise as a result of the presence of fibres at the surfaces.

The reinforcement sheet of the first aspect of the invention may comprise a further coating layer as set out herein, deposited on the second face. In other words, the composite layer may be sandwiched between two coating layers.

The composite layer may comprise the fibres as a woven or non-woven textile impregnated with the first polymer A. By impregnation it is meant that any voids or spaces between the fibres are filled with polymer A in the composite layer, whereby the composite layer is substantially free of voids, with the volume of unfilled void space being less than say 1% of the total volume. This may be measured by simple density measurement.

The composite layer suitably has a thickness from 50 to 500 μm such as 100 to 300 μm, preferably from 150 to 200 μm, more preferably from 140 to 200 μm. In an alternative preferred embodiment the composite layer has a thickness of from 200 to 300 μm.

The coating layer suitably has a thickness from 3 to 100 micrometres, such as from 5 to 50 micrometres prior to application to the composite layer. The thickness after application is suitably substantially unchanged (i.e. the same thickness as before application +/−2 micrometres). The thickness of the coating after application may be measured by optical microscopy a set out below.

The coating layer may be made by any suitable means known in the prior art, such as by melt extrusion of the polymer through a wide, T-shaped film die with adjustable gap.

Thicknesses are suitably as measured by a film thickness gauge such as a Hanatek FT3 gauge.

The second aspect of the invention provides a method of forming a reinforcement sheet according to the first aspect of the invention, the method comprising:

i) providing the composite layer comprising fibres and the first polymer A; and

ii) depositing the coating layer comprising the second polymer B onto the respective face of the composite layer.

The depositing of the coating layer may be achieved by any suitable method such as spraying of molten polymer, powder coating by deposition of a layer of powder which is subsequently melted in place to form the coating later, melt coating where polymer melt is applied as a layer then solidifies to form the coating layer, or solution coating were the polymer of the coating layer is applied as a solution in a solvent and the solvent evaporates to leave the solid polymer coating layer.

Most preferably the coating layer is deposited onto the respective face of the composite layer by film depositing the coating layer onto the composite layer with the polymer A of the composite layer in a molten state.

However, in an alternative less preferred method the coating layer is deposited onto the respective face of the composite layer by film depositing the coating layer onto the composite layer with the polymer A of the composite layer in a solidified state.

In a preferred embodiment of the second aspect of the invention, the composite layer and the coating layer are each provided as solid sheets and are pressed together and heated together to bond the coating layer to the respective face of the composite layer to form the reinforcement sheet. The pressing together and heating together may be effected in a combined process, for instance by squeezing the solid sheets together as they are passed through heated rollers. The bonding may be achieved by melting or partial melting of the polymer of the coating layer as the sheets of the composite layer and the coating layer are pressed together and heated together. It will be understood that this process is also applicable to the formation of a reinforcement sheet having a coating layer deposited onto both, opposed faces of the composite layer, and it will be understood that both coating layers may be applied simultaneously in such a process.

In an alternative, more preferred, embodiment of the second aspect of the invention, the coating layer is provided as a solid sheet and the composite layer is provided as a molten sheet and the coating layer and the composite layer are pressed together to bond the coating layer to the respective face of the composite layer to form the reinforcement sheet. The composite layer and/or the coating layer may be cooled prior to and/or during the pressing together of the coating layer and the composite layer. The pressing together and cooling may be effected in a combined process, for instance by squeezing the layers together as they are passed through cooled rollers. The bonding may be achieved by melting or partial melting of the polymer of the coating layer as the sheets of the composite layer and the coating layer are pressed together. It will be understood that this process is also applicable to the formation of a reinforcement sheet having a coating layer deposited onto both, opposed faces of the composite layer, and it will be understood that both coating layers may be applied simultaneously in such a process.

The composite layer may be provided by impregnation of polymer A as a melt into a woven or non-woven textile of the fibres, with subsequent solidification of the melt to provide the composite layer, for instance in the form of a solid sheet.

The solidification of the melt, when solidifying the composite layer, may be arranged to provide a crystallinity of 20% or more for the polymer A, preferably 25% or more, more preferably 30% or more. This may be achieved by slow cooling of the composite layer after impregnation. For instance this may be achieved by cooling through contact with ambient air (at a temperature of say 15 to 30° C.) after formation of the composite layer without forced air flow.

In an embodiment of the second aspect of the invention, the composite layer and the coating layer may be melt-bonded together by passing the two layers together through a nip between two rollers arranged to press the two layers together. The composite layer may be elevated to a temperature slightly lower than the Tm melting temperature for the polymer A in the composite layer, for instance from 5 to 20° C. lower. So, for instance, if the melting point of polymer A is 340° C., composite layer may be heated to 320-335° C. In a more preferred embodiment, the composite layer passing through the nip may be elevated to a temperature slightly higher than the Tm melting temperature for the polymer A in the composite layer, for instance from 5 to 20° C. higher. In another embodiment, the material passing through the nip may be elevated to a temperature about the same as the Tm melting temperature for the polymer A in the composite layer, for instance from 5° C. lower to 5° higher. The rollers, specifically the surfaces of the rollers at the nip may be at a lower temperature than the melting temperature for polymer B, such as 10° C. lower, 100° C. lower, 200° C. lower, 300° C. lower or less, with the composite layer including polymer A being fed into the nip with a temperature in excess of the Tm value for polymer A, such as 5° C. or more in excess of the Tm of polymer A, for instance 10° C. or more, up to say 25° C. in excess. In such an embodiment, the coating layer(s) may be at ambient temperature (say 15 to 30° C.) when fed into the nip. In this way, melt bonding may be achieved with reduced risk of the outer face of the coating layer melting onto the surfaces of the rollers. It will be understood that the same processes may be used, mutatis mutandis, for application of two coating layers to opposed faces of the composite layer.

The method of the second aspect of the invention may be arranged to provide a crystallinity of 20% or more for the polymer B, preferably 25% or more, more preferably 30% or more. For the sake of clarity, this refers to the crystallinity of the polymer B in the coating layer after the coating layer has been applied to the composite layer to form the reinforcement sheet and has stabilised to a constant crystallinity at an ambient temperature of from 15 to 30° C., such as about 20° C. The crystallinity may be considered as stable after 24 hours of storage at ambient temperature.

In fact, one of the surprising features of the invention is that the process of the second aspect of the invention may inherently lead to the polymer B of the coating layer having the required crystallinity of 20% or more. Without wishing to be bound by any scientific theory, it is thought that the presence of a high proportion of similar aryl ether ketone repeat units in common between the polymer of the coating layer and the polymer of the composite layer leads to the polymer of the composite layer providing nucleation regions which encourage high crystallinity in the polymer in the coating layer after its application to the surface of the composite layer.

A third aspect of the invention provides a method for forming an article comprising a laminate of reinforcement sheets according to the first aspect of the invention, bonded to a substrate, the method comprising:
a) melt-bonding the coating layer of a reinforcement sheet according to the first aspect of the invention to the substrate, to form a topmost bonded reinforcement sheet;
b) melt-bonding the coating layer of a further reinforcement sheet, according to the first aspect of the invention, to the bonded topmost reinforcement sheet, whereby the further reinforcement sheet becomes the topmost bonded reinforcement sheet; and
c) repeating step (b) as required to provide the laminate of reinforcement sheets.

This method of the third aspect of the invention is suitably arranged such that both the first polymer A of the composite layer and the second polymer B of the coating layer of each reinforcement sheet of the laminate each have a crystallinity of 20% or more, preferably 25% or more, more preferably 30% or more. The crystallinity may be considered as stable after 24 hours of storage at ambient temperature, and may be measured by DSC, or using FTIR calibrated to correspond to DSC values of crystallinity, as set out above.

As has already been mentioned above, one of the surprising features of the invention is that the process of the second aspect of the invention may inherently lead to the polymer B of the coating layer having the required crystallinity of 20% or more, and this inherent behaviour also applies to the third aspect of the invention. Again, without wishing to be bound to any scientific hypothesis, it is believed that the presence of crystalline regions of polymer A in the composite layers may assist in ensuring that the melt-bonded coating layers formed in the third aspect of the invention, interposed between the composite layers, achieve the required high crystallinity under ambient conditions after 24 hours storage at ambient temperature.

The substrate used in this third aspect of the invention may itself be a reinforcement sheet according to the first aspect of the invention, or may be some other article, for instance a polymeric pipe or the like.

The fourth aspect of the invention provides an article comprising a laminate of reinforcement sheets according to the first aspect of the invention. Such an article may be fabricated by the method of the third aspect of the invention, and it will be evident that the crystallinity levels set out in relation to the third aspect of the invention are also applicable to the article of the fourth aspect of the invention.

So, for each reinforcement sheet of an article according to the fourth aspect of the invention, each of the first polymer A of the respective composite layer and the second polymer B of the respective coating layer has a crystallinity of 20% or more, preferably 25% or more, more preferably 30% or more, measured as set out above.

The fibres used in the composite layer used in the various aspects of the invention may be selected from inorganic fibrous materials and non-melting and high-melting organic fibrous materials, such as aramid fibres, carbon fibre and the like.

For instance, the fibres may be selected from glass fibre, carbon fibre, asbestos fibre, silica fibre, alumina fibre, zirconia fibre, boron nitride fibre, silicon nitride fibre, boron fibre, fluorocarbon resin fibre and potassium titanate fibre. Preferred fibres are glass fibre and carbon fibre. Nanofibres may be employed.

The composite layer mentioned in the various aspects of the invention may be prepared in a substantially continuous process. In this case polymeric material (polymer A) and fibre means may be each continuously fed to a location wherein they are mixed and heated. An example of such a continuous process is extrusion. Another example involves causing a continuous filamentous mass to move through a melt or aqueous dispersion comprising polymeric material (A). The continuous filamentous mass may comprise a continuous length of fibrous filler or, more preferably, a plurality of continuous filaments which have been consolidated at least to some extent. The continuous fibrous mass may comprise a tow, roving, braid, woven fabric or unwoven fabric. The filaments which make up the fibrous mass may be arranged substantially uniformly or randomly within the mass. A composite material could be prepared as described in U.S. Pat. Nos. 4,626,306, 6,372,294, international patent application publication WO03/093354 A1, or European patent application publication EP 1215022 A1.

Without being bound by any theory, it is thought that the invention may provide for circumstances where the coating layer of the reinforcement sheet of the invention, being of low surface roughness and uniform thickness, is capable of providing high levels of auto-adhesion when melt-bonded to a substrate with this arising as a result of a high degree of intimate contact between the coating layer and the substrate. The absence of fibres from the coating layer may cause it to have a low viscosity compared to a fibre-filled composite layer, allowing a high degree of flow during melt-bonding. This may be particularly effective when the reinforcement sheet is employed in a laminated structure as described herein in relation to the third and fourth aspects of the invention. In such cases, the presence of a coating layer applied on each opposed face of a reinforcement sheet may be particularly beneficial for provision of enhanced auto-adhesion. In particular, the invention may provide for rapid crystallisation of the coating layers in use following melt-bonding into a laminated structure, with this rapid crystallisation thought to arise from the polymer A, and the polymer B, each having a high proportion of repeat units of similar chemical nature in common. The rapid crystallisation inherent in the method of the invention leads to laminated structures made according to the fourth aspect of the invention capable of having high resistance to delamination, with the bonding layers formed from the coating layers of the reinforcement sheets capable of providing high strength and high chemical resistance as a result of their high crystallinity.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a cross-sectional view of automated tape laying (ATP); and

FIG. 2 is a schematic cross sectional representation of an embodiment of a process according to the second aspect of the invention.

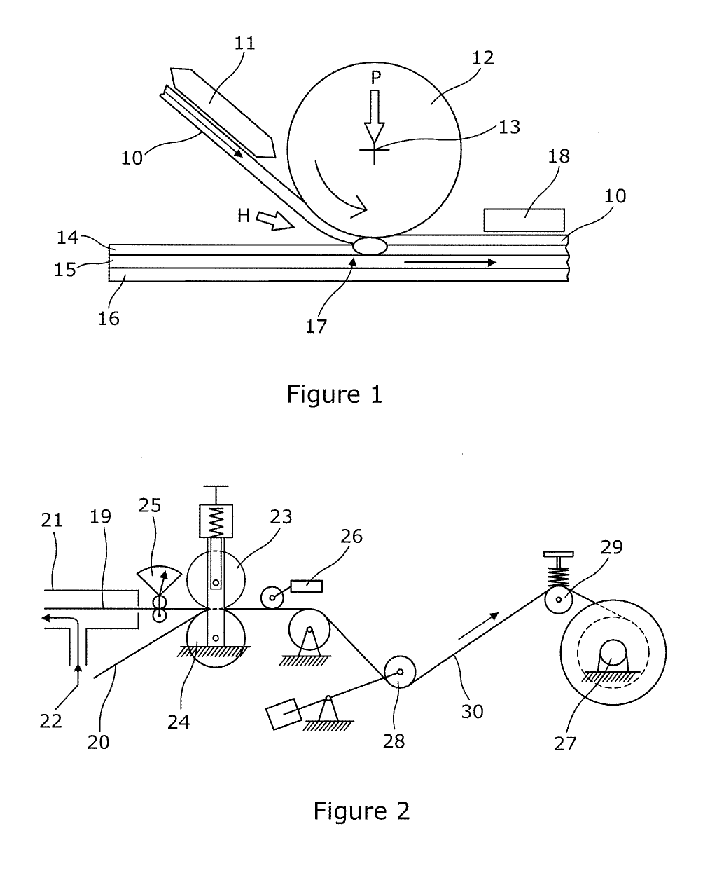

Turning to FIG. 1, a conventional ATP (Automated Tape Placement) for advanced reinforced thermoplastic materials is shown in operation.

A composite tape 10 comprising fibres and impregnated with thermoplastic polymer is fed into a nip of roller 12, rotating about an axle 13 pasta pre-heater 11 which is used to raise the temperature of the composite tape 10 to a value close to the melting point of the polymer. The nip is formed between the roller 12 and the topmost layer 14 of a laminated substrate 14, 15, 16 and the roller is pressed in the direction P to press the composite tape 10 into the topmost substrate layer 14. Heat is applied to the composite tape 10 in the nip of the roller 12 by a suitable means (such as by means of a hot air jet shown as H in FIG. 1). However, it will be understood that other heating means may be employed, such as laser heating. The roller 12 may also be at an elevated temperature in order to heat the composite tape 10 and substrate 14, 15, 16. A zone 17 in the nip of roller 12 has the polymer in a molten state as a result of the applied heat H, and this leads to melt-bonding of the composite tape 10 to the topmost layer 14 of the substrate 14, 15, 16. The material passing through the nip may be elevated to a temperature slightly lower than the Tm melting temperature for the polymer A in the composite layer, for instance from 5 to 20° C. lower. So, if the melting point of polymer A is 340° C., the nip material may be at 320-335° C. In another embodiment, the composite layer passing through the nip may be elevated to a temperature slightly higher than the Tm melting temperature for the polymer A in the composite layer, for instance from 5 to 20° C. higher. In another embodiment, the composite layer passing through the nip may be elevated to a temperature about the same as the Tm melting temperature for the polymer A in the composite layer, for instance from 5° C. lower to 5° higher. The surfaces of the rollers 23, 24 may be at a lower temperature, such as 10° C. or less, than the melting temperature for polymer A, with the composite layer including polymer A being fed into the nip with a temperature in excess of the Tm value for polymer A, such as 5° C. or more in excess of Tm, for instance 10° C. or more. In such an embodiment, the coating layer(s) may be at ambient temperature when fed into the nip. In this way, melt bonding may be achieved with reduced risk of adhesion of the coating layer to roller surfaces.

A cooling unit 18 is also provided to assist in solidification of the zone 17 after bonding. As the composite tape is melt-bonded to the substrate, the assembly of preheater 11, axle 13, roller 12 and cooling unit 18 (which are connected to move in unison) moves along the topmost layer 14 of the substrate 14, 15, 16 towards the left side of the Figure, so that the cooling unit 17 passes over the previously molten zone 17, cooling it, and the composite tape 10 is melt bonded to topmost layer 14 in a continuous manner as the roller 12 moves along the substrate. Cooling and solidification of the thermoplastic polymer leads to consolidation of the tape as part of the substrate to which it was applied.

Turning to FIG. 2, this shows a schematic cross sectional representation of an embodiment of a process according to the second aspect of the invention for forming a reinforcement sheet by applying a coating layer to a composite layer by melt-bonding.

A composite layer 19 (the formation of which is not shown in detail, but is achieved as already described above) leaves a cooling tunnel 21 where it is cooled and solidified using a cold air flow 22. In an alternative embodiment tunnel 21 is a heating tunnel 21 which ensures that composite layer 19 is molten upon arrival at a pair of rollers 23 and 24. The composite layer is drawn through rollers 23, 24, along with a coating layer 20. The roller 24 is heated and melt-bonds the coating layer 20 to the composite layer, with the rollers 23 and 24 biased together to squeeze the coating layer 20 and composite layer 19 together during the melt-bonding. As an alternative, if the composite layer 19 is molten upon arrival at rollers 23 and 24, one or more of said rollers 23 and 24 may be cooled.

Also shown are a thickness monitor 25 and a length measuring device 26, monitoring the length of reinforcement sheet delivered to the take-up spool 27. An arrangement of an adjustable pulley 28 and a tensioning pulley 29 allows for control of take-up as the reinforcement sheet 30 is collected on the take-up spool 27.

### EXAMPLES

Reinforcement sheets were formed using the process as set out above in relation to FIG. 2 using either a carbon fibre tape (Example 1) or a glass fibre tape (Example 2) as composite layer and a coating layer of Victrex® APTIV® PEEK of 5-20 micrometre thickness.

The polymer used as polymer A for the composite layer was Victrex® PEEK 150 obtained from Victrex Manufacturing Ltd, with a Tm of 340° C. and MV of 0.15 (measured at 400° C. and 1000 s⁻¹ as described above).

The PEEK used as polymer B in the coating layer coating layer was Victrex® APTIV® PEEK film (1000 series) obtained from Victrex Manufacturing Ltd: Tm 340° C.

The carbon fibre used was supplied by SGL, Mitsubishi, Toray, Hexcel, or Toho Tenax. Any carbon fibre available from SGL, Mitsubishi, Toray, Hexcel, or Toho Tenax is suitable for use in the present invention.

The glass fibre used was supplied by AGY or Owens Corning. Any glass fibre available from AGY or Owens Corning is suitable for use in the present invention.

In detail, referring to FIG. 2, coating layer 20 at ambient temperature was drawn into the nip gap between rollers 23, 24, along with the composite layer 19 (fibre tape). The surfaces of the rollers 23, 24 were maintained at a temperature below the Tg of polymer A and polymer B (i.e. specifically less than 140° C. for both A and B, typically 120° C.). In an alternative embodiment the surfaces of the rollers 23, 24 were maintained at a temperature of 60-90° C. The roller pressure was set at a level greater than 5 N/mm, preferably greater than 50 N/mm, of tape width (e.g. 6 N/mm). The composite tape 19 entered the nip between rollers 23, 24 at a temperature at least 10° C. greater than the melt temperature of polymer A (i.e. greater than 350° C. for PEEK 150G, typically 380° C.). This was also at least 10° C. greater than the melt temperature of polymer B. The line speed is 5-25 metres per minute, typically 10 metres per second.

The thickness of the coating layer was measured before application using a Hanatek thickness gauge. Mean thickness was 12.48 micrometres, with a minimum of 12.0, a maximum of 13.6 and a standard deviation of 0.28 micrometres. The thickness of the coating layer was also measured before application using XRF (X-Ray fluorescence spectrometry. Mean thickness was 12.48 micrometres, with a minimum of 12.0, a maximum of 13.6 and a standard deviation of 0.28 micrometres. It was found that the mean thickness after application as measured by XRF was 12.43 μm, with a minimum of 11.5, a maximum of 13.9 and a standard deviation of 0.30 μm.

After application of the coating layer to form the reinforcement sheet, the coating layer thickness was measured in situ using optical microscopy with an Olympus SZx10 optical microscope equipped with a graticule eyepiece calibrated against films of known thickness. A cross-section of the laminated tape was examined and the thickness recorded at multiple points across and along the cross-section, the values obtained were averaged to arrive at the thickness value.

The mean thickness after application was measured as 12.23 μm, with a minimum of 11.2 μm and a maximum=13.4 μm, with a standard deviation of 0.34 μm.

Crystallinity Values as Measured by DSC

12.5 μm APTIV PEEK coating layer before application: 31.1%

Complete carbon fibre/PEEK reinforcement sheet including coating layer: 24.6% (Example 1)

Complete glass fibre/PEEK reinforcement sheet including coating layer: 32.2% (Example 2)

Coating film after removal from the carbon fibre/PEEK reinforcement sheet: 32.1% (Example 1)

Coating film after removal from the glass fibre/PEEK reinforcement sheet: 35.6% (Example 2)

No degradation of the polymer was observed to result from the application of the coating layer. Degradation may be assessed by examination of the DSC trace: if the polymer has degraded, there will be a corresponding shift in the Tc value (crystallisation temperature on cooling form the melt) in the DSC trace, usually to a lower value, depending on the kind of degradation. In these Examples, there was no change in the Tc observed.

The surface roughness of the reinforcement sheet Examples was measured using a Form Talysurf Intra instrument using the methodology as set out above, in accordance with the standards of measurement as set out in ISO 4288:1966. The surface roughness was measured over 2 areas in 3 segments of the surface, using 4 mm data length with 5 cut-offs, and with the cut-off for Lc set as 0.8 mm and the cut-off for Ls set as 0.0025 mm, and with a bandwidth of 300:1.

The results were as follows (measured for the coating layer after application to the composite layer):

Example 1 (carbon fibre) composite layer surface roughness: Ra=1.0379

Example 1 (carbon fibre) coating layer surface roughness: Ra=0.6004

Example 2 (glass fibre) composite layer surface roughness: Ra=1.5964

Example 2 (glass fibre) coating layer surface roughness: Ra=1.0397

Hence it can be seen that the application of the coating layer leads to a significant reduction in surface roughness.

### PEEK/PEDEK EXAMPLES

A further Example (Example 3) was prepared using the following:

The polymer used as polymer A for the composite layer was Victrex® PEEK 150G obtained from Victrex Manufacturing Ltd, with a Tm of 340° C. and MV of 0.15 (measured at 400° C. and 1000 s⁻¹ as described above). The composite layer was a carbon fibre composite tape using any carbon fibre supplied by SGL, Mitsubishi, Toray, Hexcel, or Toho Tenax.

The polymer B for the coating layer was a melt extruded film of PEEK/PEDEK copolymer, Tm 305° C., MV 0.15 (measured at 400° C. and 1000 s⁻¹ as described above), with PEEK:PEDEK molar ratio 75:25.

The PEEK/PEDEK film thickness was again 5-20 μm.

Crystallinity measurements gave the following results for Example 3:

PEEK/PEDEK coating layer before application 24.2%

Sheet: carbon fibre/PEEK composite and bonded coating layer 22.7%

Coating layer after removal from reinforcement sheet 26.3%

Surface roughness measurements for Example 3 gave:

Example 1 (carbon fibre) composite layer surface roughness: Ra=1.0166

Example 1 (carbon fibre) coating layer surface roughness: Ra=0.4116

Although a few preferred embodiments have been shown and described as examples, it will be appreciated by those skilled in the art that various changes and modifications might be made without departing from the scope of the invention, as defined in the appended claims. Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at least some of such features and/or steps are mutually exclusive.

Each feature disclosed in this specification (including any accompanying claims and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A reinforcement sheet comprising:
a composite layer having first and second faces, the composite layer comprising fibres and a first polymer A, the first polymer having at least 65 mol % of a first repeat unit A′ of formula 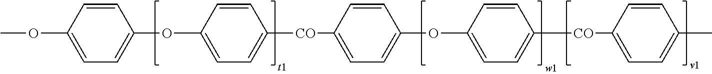
wherein t1, and w1 independently represent 0 or 1 and v1 represents 0, 1 or 2; and
a coating layer applied to the first face, and defining an interface therebetween, the coating layer comprising a second polymer B, wherein the second polymer comprises at least 65 mol % of a second repeat unit B′ of formula 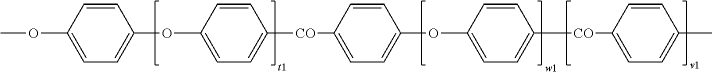
wherein t1, and w1 independently represent 0 or 1 and v1 represents 0, 1 or 2.

2. A reinforcement sheet according to claim 1 wherein the first polymer A comprises at least 90 mol % of first repeat unit A′, and preferably consists essentially of repeat unit A′.

3. A reinforcement sheet according to claim 1 wherein the first repeat unit A′ and the second repeat unit B′ are the same repeat unit, having common values for t1, w1 and v1.

4. A reinforcement sheet according to claim 3 wherein the first repeat unit A′ and the second repeat unit B′ are both according to the formula:
—O-Ph-O-Ph-CO-Ph-
wherein Ph represents a phenylene moiety.

5. A reinforcement sheet according to claim 4 wherein the second polymer B comprises from 0 mol % to 35 mol % of a third repeat unit C′ according to the formula:
—O-Ph-Ph-O-Ph-CO-Ph-
wherein Ph represents a phenylene moiety.

6. A reinforcement sheet according to claim 1 wherein the second polymer comprises at least 80 mol % of second repeat unit B′.

7. A reinforcement sheet according to claim 1, wherein the level of crystallinity in the polymeric material A is 20% or more; and the level of crystallinity in the polymeric material B is 20% or more.

8. A reinforcement sheet according to claim 1, wherein the composite layer comprises from 30 to 75% by weight of fibres and from 70 to 25% by weight of the first polymer A.

9. A reinforcement sheet according to claim 1 wherein the coating layer comprises at least 90% by weight of the second polymer B.

10. A reinforcement sheet according to claim 1 wherein the fibres of the composite layer do not extend into the coating layer.

11. A reinforcement sheet according to claim 1 wherein the coating layer has a thickness which varies by +/−2.0 micrometres or less from a mean thickness of the coating layer.

12. A reinforcement sheet according to claim 1 wherein the coating layer has a mean surface roughness Ra of 1.2 micrometres or less.

13. A reinforcement sheet according to claim 1 wherein the first and second faces of the composite layer each have a mean surface roughness Ra of 2.0 micrometres or less measured prior to any application of the coating layer.

14. A reinforcement sheet according to claim 1 comprising a further coating layer deposited on the second face.

15. A reinforcement sheet according to claim 1 wherein the composite layer comprises the fibres as a woven or non-woven textile impregnated with the first polymer A.

16. A method of forming a reinforcement sheet according to claim 1, the method comprising
i) providing the composite layer comprising fibres and the first polymer A; and
ii) depositing the coating layer comprising the second polymer B onto the respective face of the composite layer.

17. A method according to claim 16 wherein the coating layer is deposited onto the respective face of the composite layer by film depositing the coating layer onto the composite layer with the polymer A of the composite layer in a solidified state.

18. A method according to claim 16 wherein the coating layer is deposited onto the respective face of the composite layer by film depositing the coating layer onto the composite layer with the polymer A of the composite layer in a molten state.

19. A method according to claim 16 wherein the composite layer and the coating layer are each provided as a solid sheets and are pressed together and heated together to bond the coating layer to the respective face of the composite layer to form the reinforcement sheet.

20. A method according to claim 1 wherein the composite layer is provided by impregnation of polymer A as a melt into a woven or non-woven textile of the fibres, with subsequent solidification of the melt to provide the composite layer.

21. A method according to claim 20 wherein the solidification of the melt is arranged to provide a crystallinity of 20% or more for the polymer A.

22. A method according to claim 16 arranged to provide a crystallinity of 20% or more for the polymer B.

23. A method for forming an article comprising a laminate of reinforcement sheets according to claim 1, bonded to a substrate, the method comprising:
a) melt-bonding the coating layer of a reinforcement sheet according to any one of claims 1 to 15, to the substrate, to form a topmost bonded reinforcement sheet;
b) melt-bonding the coating layer of a further reinforcement sheet, according to any one of claims 1 to 15, to the bonded topmost reinforcement sheet, whereby the further reinforcement sheet becomes the topmost bonded reinforcement sheet; and
c) repeating step (b) as required to provide the laminate of reinforcement sheets.

24. An article comprising a laminate of reinforcement sheets according to claim 1.

25. An article according to claim 24 wherein for each reinforcement sheet, each of the first polymer A of the respective composite layer and the second polymer B of the respective coating layer has a crystallinity of 20% or more.
